(19) United States
(12) Patent Application Publication
(10) Pub. No.: US 2025/0118054 A1
(43) Pub. Date: Apr. 10, 2025

(54) METHOD AND SYSTEM FOR CHANGE DETECTION IN REMOTE SENSING USING SEGMENT ANYTHING MODEL

(71) Applicant: ELM, Riyadh (SA)

(72) Inventors: Farooq Mohammed Musaed ALTAM, Riyadh (SA); Thariq KHALID, Riyadh (SA); Riad SOUISSI, Riyadh (SA)

(73) Assignee: ELM, Riyadh (SA)

(21) Appl. No.: 18/746,806

(22) Filed: Jun. 18, 2024

Related U.S. Application Data
(60) Provisional application No. 63/588,164, filed on Oct. 5, 2023.

(51) Int. Cl. G06V 10/77; G06V 10/26; G06V 10/62; G06V 10/776; G06V 10/80; G06V 10/82; G06V 20/13

(52) U.S. Cl. CPC G06V 10/7715; G06V 10/26; G06V 10/62; G06V 10/806; G06V 20/13; G06V 10/776; G06V 10/82

(57) ABSTRACT

In some embodiments, a method and system for detecting surface changes in a geographical area over time is disclosed. The method includes encoding pre- and post-event images using frozen features of Segment Anything Model (SAM), processing encoded embeddings by a change modeler, processing change embeddings by a change prompter, decoding change embeddings and prompt embeddings using SAM to obtain change masks which include the detected changes.

### STATEMENT OF PRIOR DISCLOSURE BY AN INVENTOR

Aspects of the present disclosure appeared as a poster presentation in Workshop: NeurIPS 2023 Workshop on Tackling Climate Change with Machine Learning: Blending New and Existing Knowledge Systems, Dec. 10-19, 2023; SAM-CD: Change Detection in Remote Sensing Using Segment Anything Model, incorporated herein by reference in its entirety.

### CROSS-REFERENCE TO RELATED APPLICATIONS

This application claims the benefit of priority to provisional application No. 63/588,164 filed Oct. 5, 2023, the entire contents of which are incorporated herein by reference.

### BACKGROUND

### Technical Field

The present disclosure is directed to an apparatus, system, and method for change detection in remote sensing. The apparatus, system or method identifies relevant changes of a geographical location over time from two or more images of the geographical location taken at different times utilizing a Segment Anything Model.

### Description of Related Art

Change detection (CD) refers to the detection of relevant changes while ignoring irrelevant differences (e.g., shadow and imagery impairments) of the same area at different periods of time. With the high rate of city development and deterioration of the natural environment, the importance of CD is higher than ever before (See Khelifi et al., Deep learning for change detection in remote sensing images: Comprehensive review and meta-analysis. IEEE Access, 8:126385-126400, 2020). CD plays an important role in environmental and surface change monitoring, urban planning, disaster evaluation, agriculture, among many other applications (See Fonseca et al., Pattern recognition and remote sensing techniques applied to land use and land cover mapping in the brazilian savannah. Pattern Recognition Letters, 148:54-60, 2021; Demir et al., Updating land-cover maps by classification of image time series: A novel change-detection-driven transfer learning approach. IEEE Transactions on Geoscience and Remote Sensing, 51(1):300-312, 2013; and Kucharczyk et al., Remote sensing of natural hazard-related disasters with small drones: Global trends, biases, and research opportunities. Remote Sensing of Environment, 264:112577, 2021).

In bi-temporal change detection, given two input images, the pre-event image I” E [symbol] ^{N}^{²}^{×C} and the post-event image I^{t}^{₂} ∈ [symbol] ^{N}^{²}^{×C}, of the same place are taken at two different times t₁ and t₂ where N and C are the spatial and spectral dimensions of the images. The binary CD refers to detecting the accumulated change, δ^{\tilde{t}}∈{0,1}^{N}^{²}, during the period \tilde{t}=t₂-t₁. FIGS. 1A and 1B illustrate exemplary pre-event images 102, post-event images 104, and detected changes 106.

The main scheme of solving CD follows the typical techniques used in dense prediction (e.g., semantic segmentation) where an encoder, with a convolutional neural network (CNN; e.g., a ResNet or Transformer backbone), is used to extract features from the pre and post-event images (See Shi et al., A deeply supervised attention metric-based network and an open aerial image dataset for remote sensing change detection. IEEE Transactions on Geoscience and Remote Sensing, 60:1-16, 2022; and He et al., Deep residual learning for image recognition. In Proceedings of the IEEE Conference on Computer Vision and Pattern Recognition (CVPR), June 2016). The features, from both images, are then fused to form a change latent space. This space is then ingested by a decoder module to predict the change masks. Regarding training, transfer learning is the most common training procedure for CD models, where the backbone layers are trained (or fine-tuned) alongside the change fusion and decoder layers.

Siamese neural networks are currently the most successful architectures, and diverse feature fusion methods have been developed. Multi-scale fusion methods were developed to enrich the change latent space. Relation and scale-aware modules have been developed to capture interactive information of the change in both images (See Chao-Peng Chen et al., Saras-net: Scale and relation aware siamese network for change detection. In Proceedings of the Thirty-Seventh AAAI Conference on Artificial Intelligence and Thirty-Fifth Conference on Innovative Applications of Artificial Intelligence and Thirteenth Symposium on Educational Advances in Artificial Intelligence, AAAI′23/IAAI′23/EAAI′23. AAAI Press, 2023). Auxiliary losses can guide feature fusion and improve the quality of the detected masks. The wide field of view, offered by Transformer backbones, is shown to improve the context of the change features making it easier to capture long-range dependencies of the change features within the same image (using self-attention) and between the pre- and post-event images (with cross-attention).

The complexity of satellite imagery data makes CD a challenging task. However, recent advances in foundation models (FMs) bring new opportunities (See Shoufa Chen et al., Adapt-former: Adapting vision transformers for scalable visual recognition. In Advances in Neural Information Processing Systems, volume 35, pages 16664-16678, Curran Associates, Inc., 2022). Recently prompt learning in computer vision is gaining the attention of the researchers as an alternative to transfer learning and fine-tuning (See Jia et al., Visual prompt tuning. In European Conference on Computer Vision (ECCV), 2022). It becomes possible due to the emergence of efficient self-supervised, and model-in-loop training procedures.

The idea of prompt learning is to freeze the parameters of the foundation model, prompt (prepend) it with new learnable features, and train the prompt parameters only. Another powerful approach is adaptation, where a new module (adapter) is attached to the frozen foundation model and training is performed on the adapter parameters only.

Among the recently developed FMs is the Segment Anything Model (SAM), which has demonstrated a great ability in zero-shot image segmentation of different modalities. Benefiting from the powerful capabilities of SAM, in order to solve the CD problem, has not been explored before and the present disclosure shows the first SAM-based CD model.

### SUMMARY

An aspect of the present disclosure is a method of detecting surface changes in a geographical area over time. The method comprises extracting a plurality of pre-event feature map layers having a number of layers from a plurality of first uniformly sampled layers of a first input image of the geographical area taken at a first time point by a Foundation Model (FM); extracting a plurality of post-event feature map layers having the number of layers from a plurality of second uniformly sampled layers of a second input image of the geographical area taken at a first time point, wherein the second time point proceeds the first time point by the FM; producing a plurality of pre-event embeddings from the plurality of pre-event feature map layers by a projection block of a Change Modeler (CM); producing a plurality of post-event embeddings from the plurality of post-event feature map layers by the projection block of the CM; concatenating the plurality of pre-event embeddings and the plurality of post-event embeddings to generate a concatenated change embedding by the projection block of the CM; passing the concatenated change embedding through a residual block of the CM to obtain a global change embedding; transforming the global change embedding into a prompt embedding by a Change Prompter (CP); obtaining a change mask using a decoder of the FM based on the global change embedding and the prompt embedding; and identifying one or more surface changes from the change mask; wherein the CM and the CP are trainable components, and wherein the FM is a frozen component.

A further aspect of the present disclosure is a system for detecting surface changes in a geographical area over time. The system can include a non-transitory computer readable medium having instructions stored therein that, when executed by one or more processors, cause the one or more processors to perform a method of extracting a plurality of pre-event feature map layers having a number of layers from a plurality of first uniformly sampled layers of a first input image of the geographical area taken at a first time point by a Foundation Model (FM); extracting a plurality of post-event feature map layers having the number of layers from a plurality of second uniformly sampled layers of a second input image of the geographical area taken at a first time point, wherein the second time point proceeds the first time point by the FM; producing a plurality of pre-event embeddings from the plurality of pre-event feature map layers by a projection block of a Change Modeler (CM); producing a plurality of post-event embeddings from the plurality of post-event feature map layers by the projection block of the CM; concatenating the plurality of pre-event embeddings and the plurality of post-event embeddings to generate a concatenated change embedding by the projection block of the CM; passing the concatenated change embedding through a residual block of the CM to obtain a global change embedding; transforming the global change embedding into a prompt embedding by a Change Prompter (CP); obtaining a change mask using a decoder of the FM based on the global change embedding and the prompt embedding; and identifying one or more surface changes from the change mask; wherein the CM and the CP are trainable components, and wherein the FM is a frozen component.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A illustrates binary change detection with changes from Itz only, in accordance with an exemplary aspect of the disclosure;

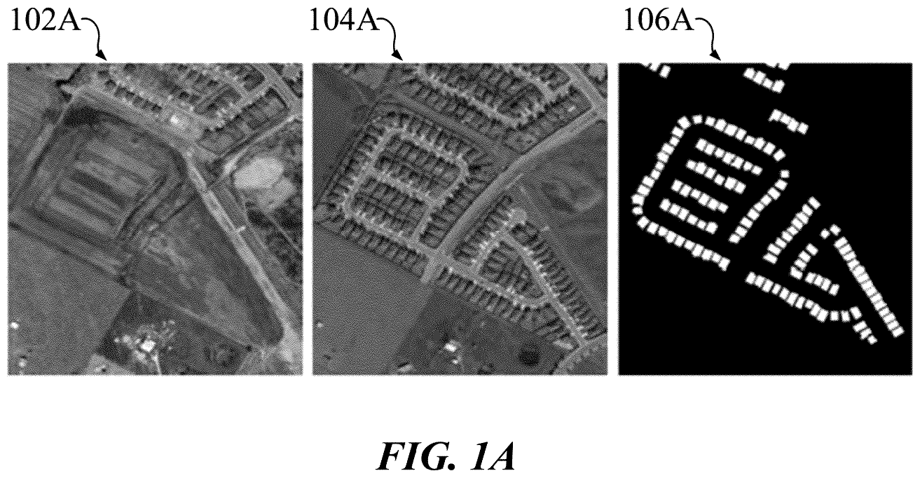

FIG. 1B illustrates binary change detection with changes from both I” and I², in accordance with an exemplary aspect of the disclosure;

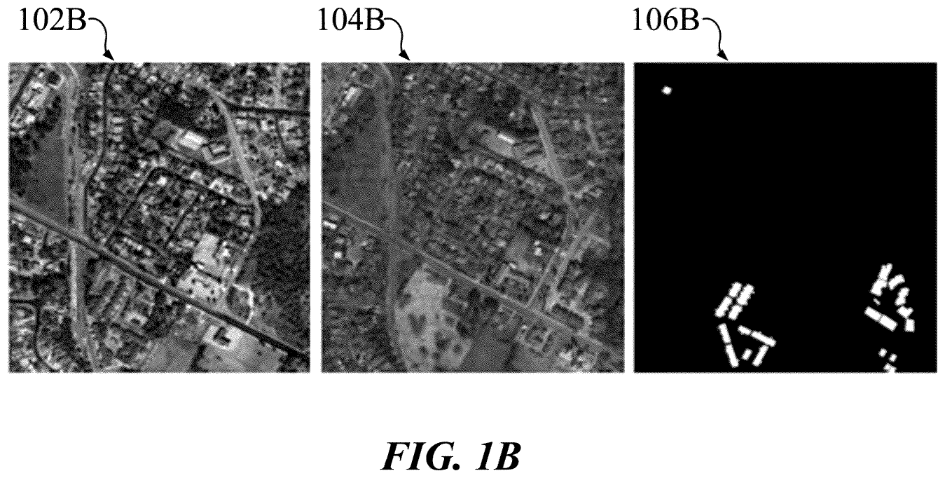

FIG. 2A is a flow diagram for the SiameseSAM architecture, in accordance with an exemplary aspect of the disclosure;

FIG. 2B is a flow diagram for the main building blocks of the SiameseSAM, in accordance with an exemplary aspect of the disclosure;

FIG. 2C is a flow diagram for the change modeler and change prompter of the SiameseSAM, in accordance with an exemplary aspect of the disclosure;

FIG. 3A an illustration of a non-limiting example of Change Detection from LEVIR-CD, according to certain embodiments;

FIG. 3B an illustration of a non-limiting example of Change Detection from DSIFN-CD, according to certain embodiments;

FIG. 4 is an illustration of a non-limiting example of details of computing hardware used in the computing system, according to certain embodiments;

FIG. 5 is an exemplary schematic diagram of a data processing system used within the computing system, according to certain embodiments;

FIG. 6 is an exemplary schematic diagram of a processor used with the computing system, according to certain embodiments; and

FIG. 7 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

The present disclosure relates to an apparatus, system and method of detecting changes in remote sensing using a FM, preferably SAM (See Kirillov et al., Segment anything, arXiv preprint arXiv:2304.02643, 2023, incorporated herein by reference in its entirety), referred as SiameseSAM. SAM was created to segment an input image using a prompt It can take multiple sparse (e.g., points, bounding boxes, etc.) and/or dense prompts (e.g., binary masks). It was trained with model-in-loop with one (1) billion binary masks.

One of the main challenges in solving change detection CD using SAM is how to model and prompt the change. SAM takes a single input image and produces segmentation masks based on prompts (e.g., points) provided by the user. On the other hand, using SAM for CD requires decoding a change latent space (from both pre-event and post event images) and learning how to prompt the change to the SAM's decoder.

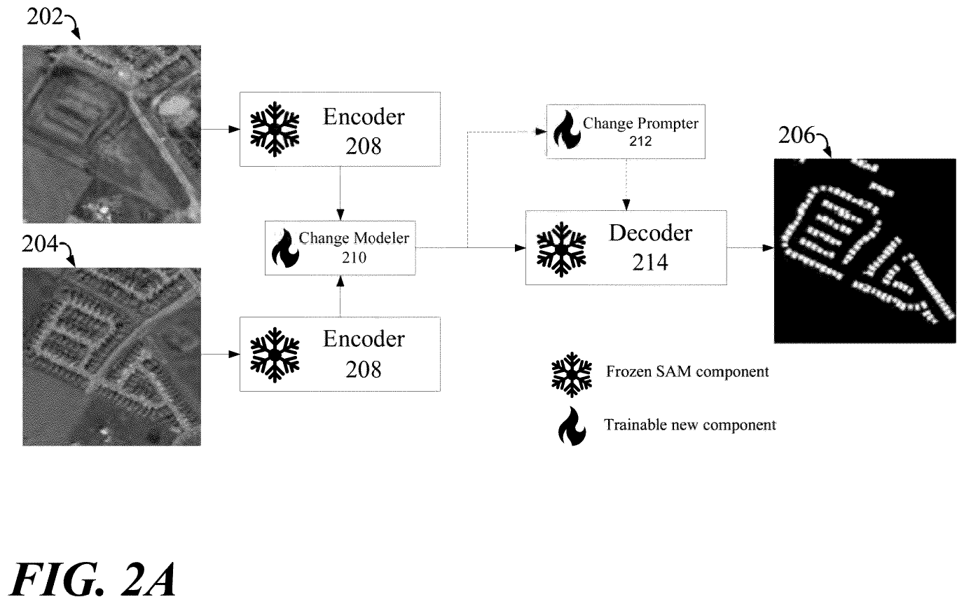

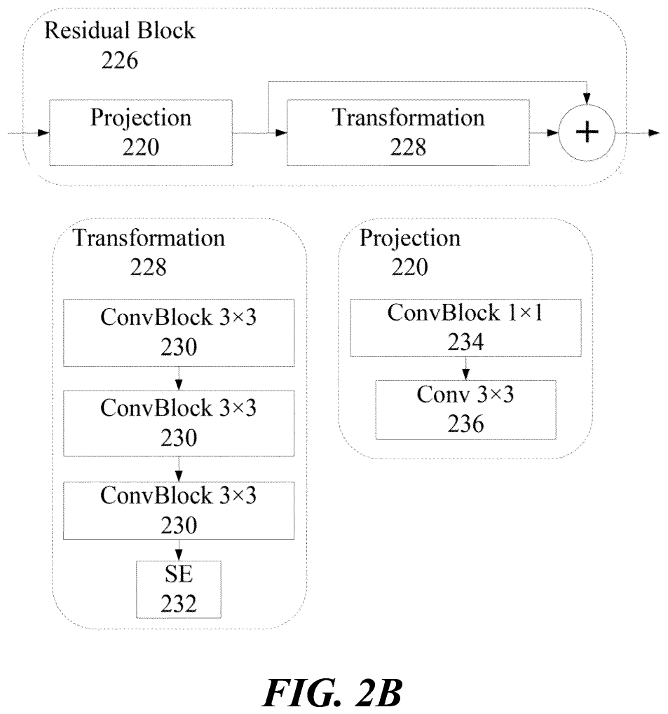

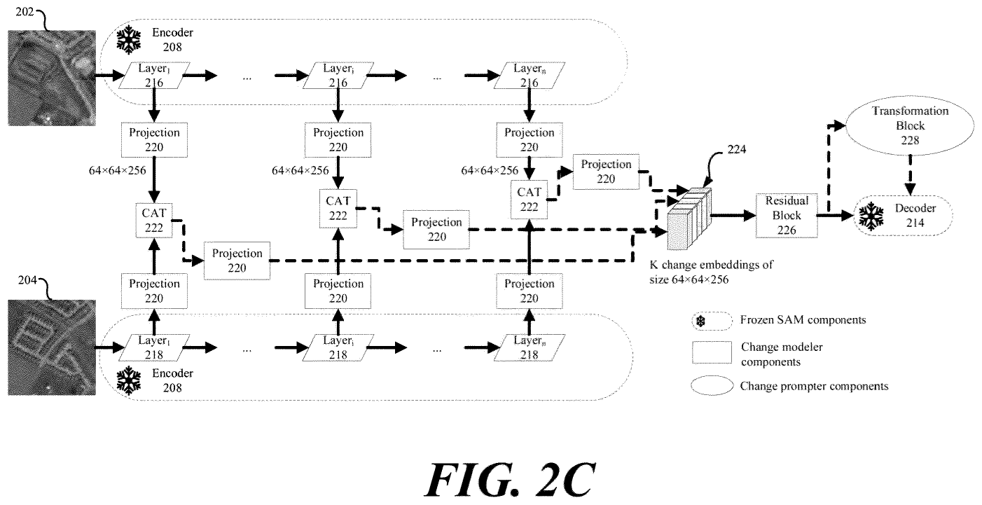

In a preferred embodiment, two new components are added: the change modeler and prompter. FIG. 2A illustrates a flow diagram of some embodiments of SiameseSAM including the two components. The change modeler 210 receives both the pre-event image 202 and post-event image 204 which are encoded by the encoder 208 of the FM and creates a change latent space. The change latent space is then used by the change prompter 212 to instruct the decoder 214 of the FM how to decode the change to obtain the detected changes 206.

FIG. 2C is a flow diagram for the change modeler and change prompter according to some embodiments. Both images are fed to the encoder. A subset, of length K, of feature maps are extracted from uniformly sampled layers of the encoder 216 and 218 and transformed as follows: each feature map is projected from 64×64×678 to an embedding of size of 64×64×256, using the projection block 220. The resulting embeddings from both images are concatenated, on the channel dimension of 64×64×512, by the concatenation operator 222 and projected from 64×64×512 to 64×64×256 to form K change embeddings of size 64×64×256 by the projection block 220. The K change embeddings are then concatenated to obtain a concatenated K change embeddings 224 and passed through a residual block 226 to obtain a global change embedding of size 64×64×256, ready to be used by the decoder 214. In some embodiments, K is preferably 5 layers.

Referring to FIG. 2B, in some embodiments, the ConvBlock 3×3 230 comprises a 2D convolution layer (Conv2D), a layer normalization (LayerNorm), and a GELU activation (GELU) (See Ba et al., Layer normalization. arXiv preprint arXiv:1607.06450, 2016; and Hendrycks and Gimpel, Gaussian error linear units (gelus). arXiv preprint arXiv:1606.08415, 2016, each incorporated herein by reference in their entirety). In another embodiments, SE 232 in the Transformation 228 is a squeeze-and-excitation layer used to recalibrate the transformed embedding before feeding it to SAM (See Jie Hu et al., Squeeze-and-excitation networks. In Proceedings of the IEEE Conference on Computer Vision and Pattern Recognition (CVPR), June 2018, incorporated herein by reference in its entirely) In yet another embodiments, Conv 3×3 236 is a simple conv2D layer with 3×3 kernel size.

Referring to FIG. 2A-C, the prompter 212 is a simple transformation block 228, which transforms the change embedding (obtained by the change modeler 210) into a prompt embedding of size 64×64×256. Both embeddings from the change modeler 210 and change prompter 212 are fed to the decoder 214 to obtain the change masks.

In some embodiments, the aim of keeping the design of SiameseSAM simple (i.e., using simple building blocks and operators without complex feature fusion modules) is to minimize the complexity of SiameseSAM in order to validate the effectiveness of using FM, preferably SAM in some embodiments, in solving CD.

In some embodiments, the detected change is compared to the state of art methods using the same Key Performance Indicators (KPIs) found in the literature to evaluate the results: e.g., Precision (Pre), Recall (Rec), F1-score (F1), and the Intersection over Union (IoU) between the predicted and Ground Truth (GT) masks. An exemplary evaluation protocol and implementation procedure are disclosed in the subsequent sections of the present disclosure.

### Example 1: LEVIR-CD

LEVIR-CD is a very high-resolution imagery dataset for building change detection (See Hao Chen et al., A spatial-temporal attention-based method and a new dataset for remote sensing image change detection. Remote Sensing, 12(10), 2020, incorporated herein by reference in its entirety). Each image is an RGB tile with a size of 1024×1024 pixels, with binary labels. LEVIR-CD is collected from Google Earth and contains 637 image pairs of which 448 are used for training, 64 for validation, and 129 for testing. The bi-temporal difference ranges from 5 to 14 years in some pairs.

### Example 2: DSIFN-CD

DSIFN-CD is a high-resolution imagery dataset collected from six different cities in China using Google Earth (See Zhang et al., A deeply supervised image fusion network for change detection in high resolution bi-temporal remote sensing images. ISPRS Journal of Photogrammetry and Remote Sensing, 166:183-200, 2020, incorporated herein by reference in its entirety). It contains 3940 pairs of size 512×512 cropped from six large tiles. The training and validation sets are selected from five cities with 3600 and 340 pairs for training and validation, respectively. The testing set contains 48 pairs from the sixth city only, and this dataset contains various classes of changes: roads, buildings, croplands, and water bodies with bi-temporal difference ranges from 5 to 17 years. DSIFN-CD is considered to be a challenging dataset due to change complexity and the intra-city diversity between the training and testing sets.

### Example 3: SiameseSAM

In accordance with some embodiments, the results of SiameseSAM and other models for both LEVIR-CD and DSIFN-CD datasets are shown in Table 1 (See Daudt et al., Fully convolutional siamese networks for change detection. In 2018 25th IEEE International Conference on Image Processing (ICIP), pages 4063-4067, 2018; Guo et al., Augfpn: Improving multi-scale feature learning for object detection. In 2020 IEEE/CVF Conference on Computer Vision and Pattern Recognition (CVPR), pages 12592-12601, Los Alamitos, CA, USA, Jun 2020. IEEE Computer Society; Bandara et al., A transformer-based siamese network for change detection, In IGARSS 2022-2022 IEEE International Geoscience and Remote Sensing Symposium, pages 207-210, 2022; and Lei et al., Ultralightweight spatial-spectral feature cooperation network for change detection in remote sensing images. IEEE Transactions on Geoscience and Remote Sensing, 61:1-14, 2023, each incorporated herein by reference in their entirety). Regarding LEVIR-CD, SiameseSAM achieved the best results and is ahead of the second-best model USSFC-NET by about +2.46%, −2.51%, 0.02% and 0.48% in precision, recall, IoU, and F1-score, respectively. When considering the results of DSIFN-CD in some embodiments, which is more challenging, SiameseSAM achieves the state of art in all metrics except the recall, outperforming the second-best model USSFC-NET with about +0.77%, −2.07%, +2.44%, and +1.55% in in precision, recall, IoU, and F1-score, respectively.

In some embodiments, SiameseSAM is consistent in both datasets, which is reflected by the high F1-score in both datasets. In addition, visual inspection results are reported in Example 6.

TABLE 1
The change detection results of the LEVIR-CD and DSIFN-CD test sets
with emphasis added to denote the highest evaluation scores.

| | | LEVIR-CD | | | | DSIFN-CD | | | |
|---|---|---|---|---|---|---|---|---|---|
| Model | Year | Pre | Rec | IoU | F1 | Pre | Rec | IoU | F1 |
| FC-Siam-Conc | 2018 | 31.99 | 76.77 | 71.96 | 83.69 | 59.08 | 62.80 | 43.76 | 60.88 |
| STANet | 2020 | 83.81 | 91.00 | 77.40 | 87.26 | 51.48 | 36.40 | 27.11 | 42.65 |
| BIT | 2022 | 89.24 | 89.37 | 80.68 | 89.31 | 56.36 | 62.79 | 42.25 | 59.40 |
| USSFC-NET | 2023 | 89.70 | 93.42 | 84.36 | 91.04 | 63.73 | 76.32 | 53.20 | 69.47 |
| SiameseSAM | | 92.16 | 90.91 | 84.38 | 91.52 | 68.42 | 74.25 | 55.64 | 71.02 |

In some embodiments, during training, the change modeler and the change prompter are the only trainable parts of SiameseSAM architecture, while the parameters of SAM were kept frozen. In some embodiments, SiameseSAM not only achieved state of the art when evaluated on two challenging CD datasets, but also produced consistent results.

In some embodiments, employing FMs for CD will help to accelerate the analysis of climate change problems. The present disclosure provides new CD solutions that leverage prompt learning and foundation model adaptation. In some embodiments, new prompting designs and advanced feature fusion methods are implemented.

### Example 4: SiameseSAM Formulation

In some embodiments, SAM includes three main building blocks: the image and prompt encoders, and a mask decoder. At the inference time, SAM receives an image I∈R^{N}^{^{2×C}} and a prompt P and produces a set of masks.

In some embodiments, the image encoder, Eᵢₙ, is a masked auto-encoder (MAE) model, and there are two prompt encoders, Eₛₚₐᵣₛₑ for sparse prompts, and E_{dense} for dense prompts (See He et al., Masked autoencoders are scalable vision learners. In Proceedings of the IEEE/CVF Conference on Computer Vision and Pattern Recognition (CVPR), pages 16000-16009, June 2022, incorporated herein by reference in its entirety). In some embodiments, for sparse prompts, Eₛₚₐᵣₛₑ is a simple layer that learns positional embeddings of points and bounding boxes. In some embodiments, for dense prompts, E_{dense} is a CNN module. In some embodiments, the mask decoder Dₘₐₛₖ is a Transformer module that decodes the image embeddings using the prompt embeddings. In some embodiments, SAM can be modeled as:

SAM: Dₘₐₛₖ(Eᵢₙ(I))

Prompted by: {E_{dense}(mask),Cat_{c}(Eₛₚₐᵣₛₑ(Pₚₒᵢₙₜₛ),τ^{out}))} (1)

where τ^{out} is the set of output trainable tokens, and Cat_{c} is a concatenation operator 222 applied on the channel dimension.

In some embodiments, for a given CD dataset X, and a pre-trained SAM model with frozen parameters θ, and the change trainable parameters ϑ, the CD objective is to find ϑ that minimizes the change prediction function ƒ:

$${min}_{ϑ} 𝔼 \{ ( {I}^{{t}_{1}} , {I}^{{t}_{2}} ) , {δ}^{\tilde{t}} \} \sim {χ}^{L ( f ( {I}^{{t}_{1}} , {I}^{{t}_{2}} ; θ , ϑ ) , {δ}^{\tilde{t}} )} \qquad ( 2 )$$

where ƒ is the SiameseSAM, and L is the adopted loss function which is a combination of the dice and binary cross entropy losses:

$$ℒ ( {M}^{\tilde{t}} , {δ}^{\tilde{t}} ) = - \frac{1}{B} {\sum }_{b = 1}^{B} ( \frac{1}{2} {δ}_{b}^{\tilde{t}} log {M}_{b}^{\tilde{t}} + \frac{2 {δ}_{b}^{\tilde{t}} {M}_{b}^{\tilde{t}}}{{δ}_{b}^{\tilde{t}} + {M}_{b}^{\tilde{t}}} ) \qquad ( 3 )$$

where M^{\tilde{t}} is the obtained logits from ƒ and B is the batch size (See Zhou et al., Unet++: A nested u-net architecture for medical image segmentation. In Deep Learning in Medical Image Analysis and Multimodal Learning for Clinical Decision Support, pages 3-11, Cham, 2018. Springer International Publishing, incorporated herein by reference in its entirety).

In some embodiments, following the presented formulation for SAM in (1), SiameseSAM can be formulated likewise as:

SiameseSAM: Dₘₐₛ(S^{\tilde{t}})

prompted by:{P^{\tilde{t}},cat_{c}(ϕ,τ^{out}) (4)

where S^{\tilde{t}} is the change embedding obtained by the change modeler, and Pt is the change prompt embedding obtained from the change prompter. cat_{c} is the concatenation operator 222 applied on the channel dimension, and # is the SAM's pre-trained no-prompt token.

### Example 5: Evaluation protocol and implementation details

In some embodiments, the KPIs used in the evaluation are the same ones used in some literature:

$$Precision = \frac{TP}{TP + FP} \qquad ( 5 )$$

$$Recall = \frac{TP}{TP + FN} \qquad ( 6 )$$

$$Intersection over Union = \frac{TP}{TP + FN + FP} \qquad ( 7 )$$

$$F 1 - score = 2 \times \frac{Precision \times Recall}{Precision + Recall} \qquad ( 8 )$$

In some embodiments, SiameseSAM is implemented in PyTorch, and the adopted SAM model is the sam-vit-h, where its weights are frozen while the change modeler 210 and prompter blocks 212 are initialized randomly. The number of layers sampled from SAM's encoder to model the change is K=5. In some embodiments, the optimizer used to train the SiameseSAM is the AdamW, with the adopted hyper-parameters as shown in Table 2.

TABLE 2
The parameters being adopted for training.

| Parameter | Value |
|---|---|
| Initial RL | 0.001 |
| Momentum | 0.9 |
| Weight decay | 0.00001 |
| Training Schedules | 400 epochs (for LEVIR-CD) and |
| | 100 epochs (for DSIFN-CD) |
| Scheduler | CosineScheduler with minimum RL = 0 |
| Hardware | V100 GPU |
| Batch Size | 8 |

In accordance with some embodiments, flip, rotate, scale, and clip augmentations were used during training and the input is scaled to 1024×1024 for both datasets, and no augmentation was applied during the inference time.

### Example 6: Visual Results

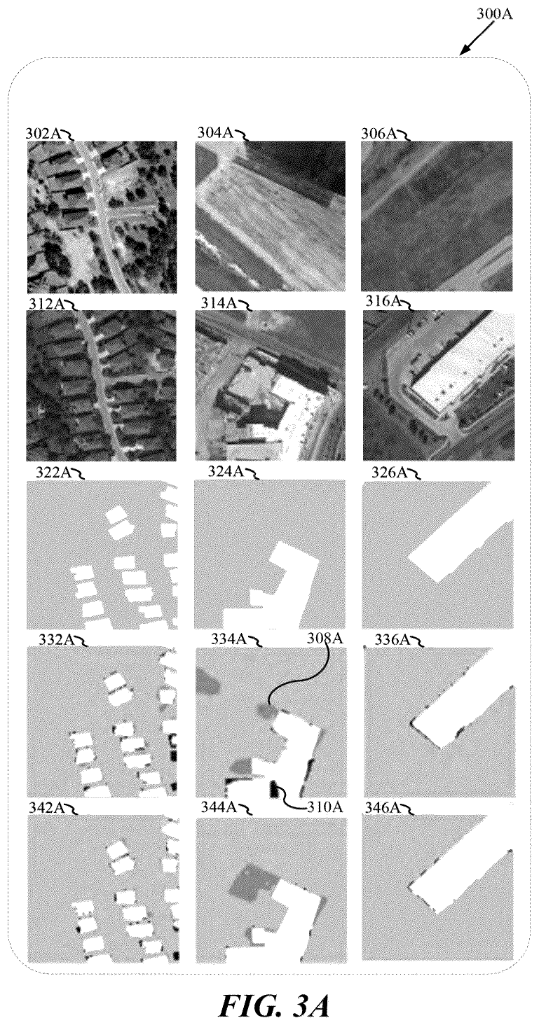

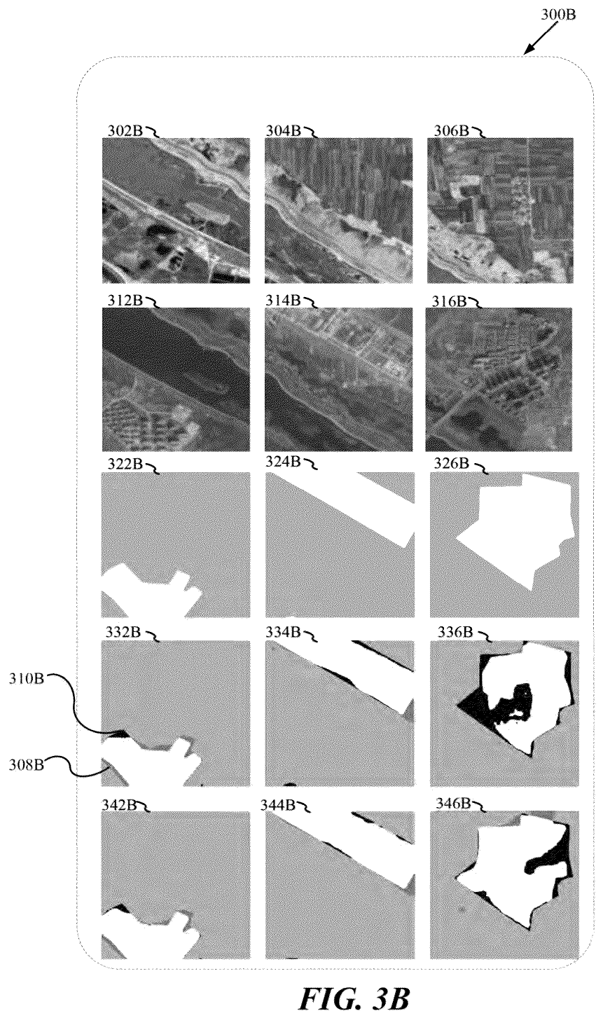

FIG. 3A illustrates exemplary visual inspection results of CD 300A from LEVIR-CD test set. The visual inspection results of CD 300A include a pre-event image 302A, 304A, 306A, a post-event image 312A, 314A, 316A, a ground truth 322A, 324A, 326A, CD based on USSFC-NET 332A, 334A, 336A, and CD based on SiameseSAM 342A, 344A, 346A. The visual inspection results of CD 300A further include a false negative 310A, shown as black marking, and a false positive 308A, shown as grey marking. In accordance with some embodiments, the visual inspection results of CD 300A indicates that SiameseSAM provides less false positive and/or negative areas compared to USSFC-NET. FIG. 3B illustrates exemplary visual inspection results of CD 300B from DSIFN-CD test set. The visual inspection results of CD 300B include a pre-event image 302B, 304B, 306B, a post-event image 312B, 314B, 316B, a ground truth 322B, 324B, 326B, CD based on USSFC-NET 332B, 334B, 336B, and CD based on SiameseSAM 342B, 344B, 346B. The visual inspection results of CD 300B further include a false negative 310B, shown as black marking, and a false positive 308B, shown as grey marking. In accordance with some embodiments, SiameseSAM provides lesser false positive and/or negative areas compared to USSFC-NET from DSIFN-CD set, which is considered more challenging due to the complexity of the background and diversity of the change classes, than LEVIR-CD set.

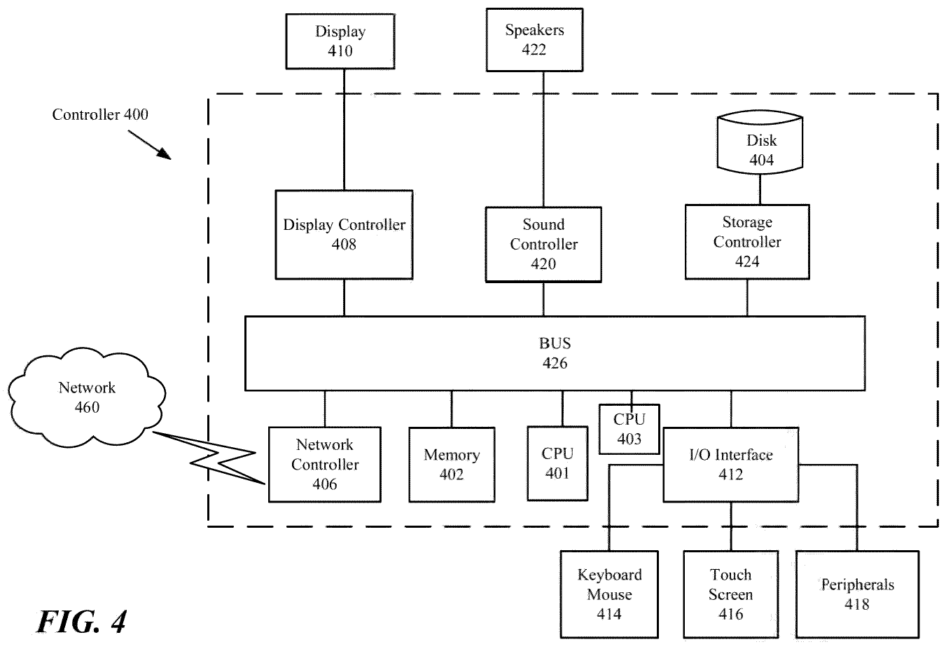

The hardware description of the computing environment according to exemplary embodiments is described with reference to FIG. 4. In FIG. 4, a controller 400 is described as representative of the system for SiameseSAM in which the controller is a computing device which includes a CPU 401 which performs the processes described above/below. The process data and instructions may be stored in memory 402. These processes and instructions may also be stored on a storage medium disk 404 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 401, 403 and an operating system such as Microsoft Windows 7, Microsoft Windows 10, Microsoft Windows 11, UNIX, Solaris, LINUX, Apple MAC-OS, and other systems known to those skilled in the art.

The hardware elements in order to achieve the computing device may be realized by various circuitry elements, known to those skilled in the art. For example, CPU 401 or CPU 403 may be a Xenon or Core processor from Intel of America or an Opteron processor from AMD of America, or may be other processor types that would be recognized by one of ordinary skill in the art. Alternatively, the CPU 401, 403 may be implemented on an FPGA, ASIC, PLD or using discrete logic circuits, as one of ordinary skill in the art would recognize. Further, CPU 401, 403 may be implemented as multiple processors cooperatively working in parallel to perform the instructions of the inventive processes described above.

The computing device in FIG. 4 also includes a network controller 406, such as an Intel Ethernet PRO network interface card from Intel Corporation of America, for interfacing with network 460. As can be appreciated, the network 460 can be a public network, such as the Internet, or a private network such as an LAN or WAN network, or any combination thereof and can also include PSTN or ISDN sub-networks. The network 460 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 408, such as a NVIDIA GeForce GTX or Quadro graphics adaptor from NVIDIA Corporation of America for interfacing with display 410, such as a Hewlett Packard HPL2445w LCD monitor. A general purpose I/O interface 412 interfaces with a keyboard and/or mouse 414 as well as a touch screen panel 416 on or separate from display 410. General purpose I/O interface also connects to a variety of peripherals 418 including printers and scanners, such as an OfficeJet or DeskJet from Hewlett Packard.

A sound controller 420 is also provided in the computing device such as Sound Blaster X-Fi Titanium from Creative, to interface with speakers/microphone 422 thereby providing sounds and/or music.

The general purpose storage controller 424 connects the storage medium disk 404 with communication bus 426, which may be an ISA, EISA, VESA, PCI, or similar, for interconnecting all of the components of the computing device. A description of the general features and functionality of the display 410, keyboard and/or mouse 414, as well as the display controller 408, storage controller 424, network controller 406, sound controller 420, and general purpose I/O interface 412 is omitted herein for brevity as these features are known.

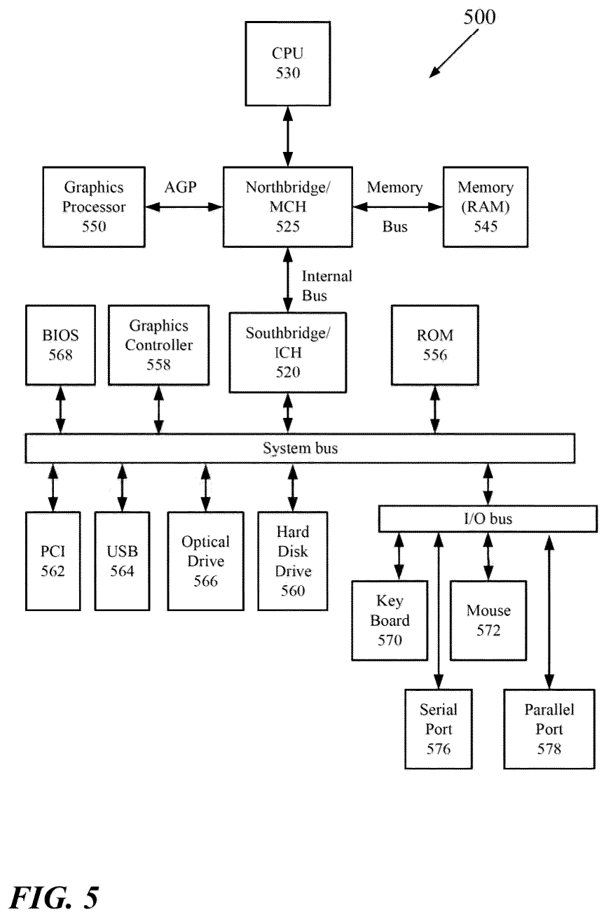

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 5.

FIG. 5 shows a schematic diagram of a data processing system, according to some embodiments, for performing the functions of the exemplary embodiments. The data processing system is an example of a computer in which code or instructions implementing the processes of the illustrative embodiments may be located.

In FIG. 5, data processing system 500 employs a hub architecture including a north bridge and memory controller hub (NB/MCH) 525 and a south bridge and input/output (I/O) controller hub (SB/ICH) 520. The central processing unit (CPU) 530 is connected to NB/MCH 525. The NB/MCH 525 also connects to the memory 545 via a memory bus, and connects to the graphics processor 550 via an accelerated graphics port (AGP). The NB/MCH 525 also connects to the SB/ICH 520 via an internal bus (e.g., a unified media interface or a direct media interface). The CPU Processing unit 530 may contain one or more processors and even may be implemented using one or more heterogeneous processor systems.

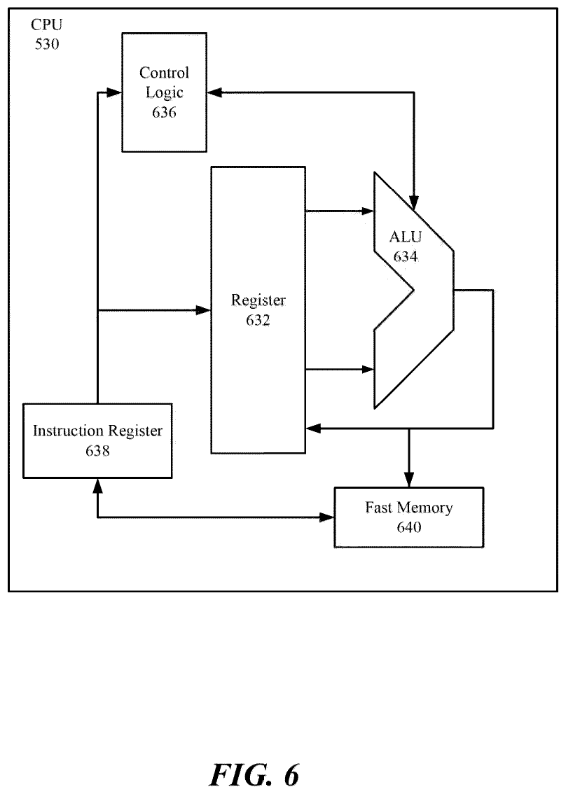

For example, FIG. 6 shows one implementation of CPU 530. In one implementation, the instruction register 638 retrieves instructions from the fast memory 640. At least part of these instructions are fetched from the instruction register 638 by the control logic 636 and interpreted according to the instruction set architecture of the CPU 530. Part of the instructions can also be directed to the register 632. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 634 that loads values from the register 632 and performs logical and mathematical operations on the loaded values according to the instructions. The results from these operations can be feedback into the register and/or stored in the fast memory 640. According to certain implementations, the instruction set architecture of the CPU 530 can use a reduced instruction set architecture, a complex instruction set architecture, a vector processor architecture, a very large instruction word architecture. Furthermore, the CPU 530 can be based on the Von Neuman model or the Harvard model. The CPU 530 can be a digital signal processor, an FPGA, an ASIC, a PLA, a PLD, or a CPLD. Further, the CPU 530 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 5, the data processing system 500 can include that the SB/ICH 520 is coupled through a system bus to an I/O Bus, a read only memory (ROM) 556, universal serial bus (USB) port 564, a flash binary input/output system (BIOS) 568, and a graphics controller 558. PCI/PCIe devices can also be coupled to SB/ICH 588 through a PCI bus 562.

The PCI devices may include, for example, Ethernet adapters, add-in cards, and PC cards for notebook computers. The Hard disk drive 560 and CD-ROM 566 can use, for example, an integrated drive electronics (IDE) or serial advanced technology attachment (SATA) interface. In one implementation the I/O bus can include a super I/O (SIO) device.

Further, the hard disk drive (HDD) 560 and optical drive 566 can also be coupled to the SB/ICH 520 through a system bus. In one implementation, a keyboard 570, a mouse 572, a parallel port 578, and a serial port 576 can be connected to the system bus through the I/O bus. Other peripherals and devices that can be connected to the SB/ICH 520 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

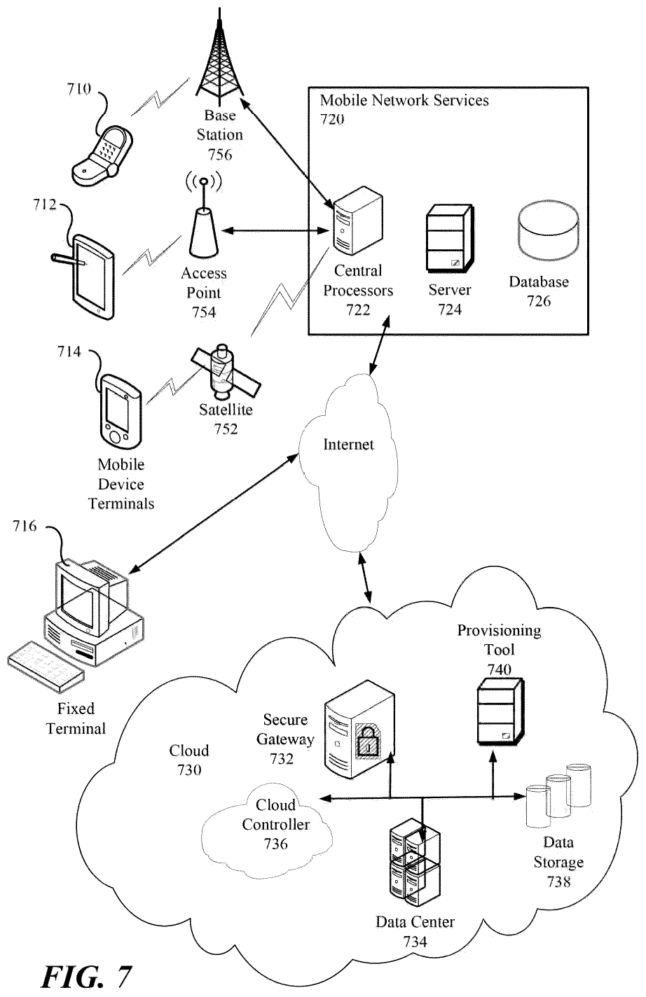

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 7, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

Additionally, some aspects of the present disclosure may be performed on modules or hardware not identical to those described. The above-described hardware description is a non-limiting example of corresponding structure for performing the functionality described herein.

Numerous modifications and variations of the present invention are possible in light of the above teachings. It is therefore to be understood that within the scope of the appended claims, the invention may be practiced otherwise than as specifically described herein.

1. A method of detecting surface changes in a geographical area over time, comprising:
extracting a plurality of pre-event feature map layers having a number of layers from a plurality of first uniformly sampled layers of a first input image of the geographical area taken at a first time point by a Foundation Model (FM);
extracting a plurality of post-event feature map layers having a number of layers from a plurality of second uniformly sampled layers of a second input image of the geographical area taken at a first time point, wherein the second time point is after the first time point by the FM;
producing a plurality of pre-event embeddings from the plurality of pre-event feature map layers by a projection block of a Change Modeler (CM);
producing a plurality of post-event embeddings from the plurality of post-event feature map layers by the projection block of the CM;
concatenating the plurality of pre-event embeddings and the plurality of post-event embeddings to generate a concatenated change embedding by the projection block of the CM;
passing the concatenated change embedding through a residual block of the CM to obtain a global change embedding;
transforming the global change embedding into a prompt embedding by a Change Prompter (CP);
obtaining a change mask using a decoder of the FM based on the global change embedding and the prompt embedding; and
identifying one or more surface changes from the change mask;
wherein the CM and the CP are trainable components, and wherein the FM is a frozen component.

2. The method of claim 1, wherein the FM is Segment Anything Model (SAM).

3. The method of claim 2, wherein the concatenating further comprises:
concatenating each of the plurality of pre-event embeddings and a corresponding post-event embedding of the plurality of post-event embeddings having a same number of layers to generate a plurality of embedding pairs; and
concatenating the plurality of embedding pairs and passing through the residual bock of the CM to obtain the global change embedding.

4. The method of claim 3, wherein the plurality of pre-event and post-event feature map layers has a first dimension of 64×64×678, the of pre-event and post-event embeddings have a second dimension of 64×64×256, the plurality of embedding pairs has a channel dimension of 64×64×512.

5. The method of claim 4, wherein the concatenated change embedding is four (4) dimensional having a fourth dimension of the number of layers×64×64×256.

6. The method of claim 5, wherein the number of layers is five (5) layers and the fourth dimension is 5×64×64×256.

7. The method of claim 6, wherein the global change and prompt embeddings have a fifth dimension of 64×64×256.

8. The method of claim 2, wherein the residual block comprises a transformation block and the projection block.

9. The method of claim 8, wherein the transformation block further comprises a plurality of first ConvBlocks having a two-dimensional convolution layer, a layer normalization, and a GELU activation and a squeeze-and-excitation layer.

10. The method of claim 8, wherein the projection block further comprises a second ConvBlock and a Conv2D having a kernel size of 3×3.

11. The method of claim 1, wherein the method does not include a complex feature fusion module.

12. A system for detecting a surface change in a geographical area over time, comprising:
a processor configured to execute a program instruction;
an input device configured to receive a plurality of images of the geographical area; and
a storage device configured to store the program instruction and the plurality of input images;
wherein the program instruction comprises:
extracting a plurality of pre-event feature map layers having a number of layers from a plurality of first uniformly sampled layers of a first input image of the geographical area taken at a first time point by a Foundation Model (FM);
extracting a plurality of post-event feature map layers having the number of layers from a plurality of second uniformly sampled layers of a second input image of the geographical area taken at a first time point, wherein the second time point proceeds the first time point by the FM;
producing a plurality of pre-event embeddings from the plurality of pre-event feature map layers by a projection block of a Change Modeler (CM);
producing a plurality of post-event embeddings from the plurality of post-event feature map layers by the projection block of the CM;
concatenating the plurality of pre-event embeddings and the plurality of post-event embeddings to generate a concatenated change embedding by the projection block of the CM;
passing the concatenated change embedding through a residual block of the CM to obtain a global change embedding;
transforming the global change embedding into a prompt embedding by a Change Prompter (CP);
obtaining a change mask using a decoder of the FM based on the global change embedding and the prompt embedding; and
identifying one or more surface changes from the change mask;
wherein the CM and the CP are trainable components, and wherein the FM is a frozen component.

13. The system of claim 12, wherein the FM is Segment Anything Model (SAM).

14. The system of claim 13, wherein the concatenating further comprises:
concatenating each of the plurality of pre-event embeddings and a corresponding post-event embedding of the plurality of post-event embeddings having a same number of layers to generate a plurality of embedding pairs; and
concatenating the plurality of embedding pairs and passing through the residual bock of the CM to obtain the global change embedding.

15. The system of claim 14, wherein the plurality of pre-event and post-event feature map layers has a first dimension of 64×64×678, the pre-event and post-event embeddings have a second dimension of 64×64×256, the plurality of embedding pairs has a channel dimension of 64×64×512, the concatenated change embedding is four (4) dimensional having a fourth dimension of 5×64×64×256, and the global change and prompt embeddings have a fifth dimension of 64×64×256.

16. The system of claim 15, wherein the residual block comprises a transformation block and the projection block.

17. The system of claim 16, wherein the transformation block further comprises a plurality of first ConvBlocks having a two-dimensional convolution layer, a layer normalization, and a GELU activation and a squeeze-and-excitation layer.

18. The system of claim 16, wherein the projection block further comprises a second ConvBlock and a Conv2D having a kernel size of 3×3.

19. The system of claim 16, wherein the method does not include a complex feature fusion module.
